(19) United States
(12) Patent Application Publication
(10) Pub. No.: US 2016/0218543 A1
(43) Pub. Date: Jul. 28, 2016

(54) ELECTRIC POWER SYSTEM CONTROL DEVICE, ELECTRIC POWER SYSTEM, AND ELECTRIC POWER SYSTEM CONTROL METHOD

(71) Applicant: Hitachi, Ltd., Tokyo (JP)

(72) Inventors: Takaharu ISHIDA, Tokyo (JP); Shinsuke ANDOH, Tokyo (JP); Hiroki SATOH, Tokyo (JP); Hideyuki KOBAYASHI, Tokyo (JP); Kazuya SHOJIKI, Tokyo (JP)

(73) Assignee: Hitachi, Limited, Tokyo (JP)

(21) Appl. No.: 14/913,729

(22) PCT Filed: Sep. 27, 2013
(86) PCT No.: PCT/JP2013/076184

§ 371 Date: Feb. 23, 2016

(51) Int. Cl. H02J 7/00

(52) U.S. Cl. CPC H02J 7/0068

(57) ABSTRACT

The electric power loss at the time of charging/discharging storage batteries is reduced. An electric power system control device maintains a balance of power supply and demand of an electric power system by controlling charging/discharging of a storage battery, and includes a frequency detection unit; a frequency prediction unit which predicts the frequency from the frequency calculated by the frequency detection unit and history data of power generation/load supply-demand data. A charging/discharging amount determination unit sets a charging/discharging amount corresponding to a value lower or higher than the frequency of the electric power system predicted by the frequency prediction unit within a range not exceeding a lower or higher limit value of the frequency and determines the charging/discharging amount of the storage battery based on the value. And, a control command unit transmits a control command to the storage battery based on a result of the charging/discharging amount determination unit.

### TECHNICAL FIELD

The present invention relates to an electric power system control device and an electric power system control method of performing control of an electric power system by using a storage battery.

### BACKGROUND ART

As a background art of the present invention, there is JP 2012-16077 A (Patent Document 1). The cited art is to provide a frequency control device of an electric power system capable of appropriately controlling charging/discharging of a secondary battery according to an unbalance of power supply and demand. Disclosed is a technique where a depth of charge of the secondary battery is maintained near 50% by correcting the depth of charge of the secondary battery so that the depth of charge of the secondary battery is 50%, and when an unbalance of power supply and demand occurs, any one of the charging and discharging of the secondary battery can be controlled at the same degree.

### CITATION LIST

### Patent Document

Patent Document 1: JP 2012-16077 A

### SUMMARY OF INVENTION

### Technical Problem

The technique of Patent Document 1 is applied to an ancillary service performed by a storage battery service provider, and in the case of performing charging/discharging control for maintaining the frequency, since electric power loss at the time of charging/discharging of the storage batteries is not considered, the electric power of the electric power loss needs to be a burden for the storage battery service provider side. Therefore, if the storage battery service provider performs the charging/discharging of the storage batteries in order to maintain the frequency designated by the electric power system, the burden of the storage battery service provider corresponding to the electric power loss is increased, so that a newly participating storage battery service provider has disadvantages in terms of costs.

The present invention is to reduce the electric power loss at the time of charging/discharging the storage batteries.

### Solution to Problem

As described in “Technical Problem”, in the ancillary service (control for maintaining stability of the electric power system) using the storage batteries, since the electric power loss occurs in performing AC-DC conversion at the time of charging/discharging the storage batteries, all the charging electric power amount purchased by the storage battery service provider cannot be discharged. Therefore, in order to supply the electric power according to the command value for maintaining the electric power system from the storage batteries, it is necessary to secure an electric power amount which is added with the electric power amount corresponding to the electric power loss in advance or an electric power amount considering the deterioration of the storage batteries. In the present invention, in order to reduce the cost thereof, the charging/discharging amount from the storage batteries is determined by setting the charging/discharging amount satisfying a lower limit value of frequency that is an index of the electric power system as a target value.

As a representative example of the electric power system control device according to the present invention, there is provided an electric power system control device of maintaining a balance of power supply and demand of an electric power system by controlling charging/discharging of a storage battery associated with the electric power system based on a predicted frequency value after several seconds or minutes of the electric power system, including: a frequency detection unit which calculates a frequency of the electric power system; a frequency prediction unit which predicts the frequency from the value of the frequency calculated by the frequency detection unit and history data of power generation/load supply-demand data; a charging/discharging amount determination unit which sets a charging/discharging amount corresponding to a value lower or higher than the predicted frequency value of the electric power system predicted by the frequency prediction unit within a range not exceeding a lower or higher limit value of the frequency and determines the charging/discharging amount of the storage battery based on the value; and a control command unit which transmits a control command to the storage battery based on a result of the charging/discharging amount determination unit.

In the electric power system control device according to the present invention, the charging/discharging amount determination unit may determine the charging/discharging amount of a plurality of the storage batteries by using minimization of electric power conversion losses of the storage batteries as an objective function.

In addition, in the electric power system control device according to the present invention, the charging/discharging amount determination unit may determine the charging/discharging amount of a plurality of the storage batteries by using reduction of deterioration of the storage batteries as an objective function.

As an example of the electric power system control method according to the present invention, there is provided an electric power system control method of maintaining a balance of power supply and demand of an electric power system by controlling charging/discharging of a storage battery associated with the electric power system based on a predicted frequency value after several seconds or minutes of the electric power system, including: calculating a frequency of the electric power system; predicting the frequency from history data including a value of the calculated frequency and power generation/load supply-demand data; setting a charging/discharging amount corresponding to a value lower or higher than the predicted frequency value of the electric power system within a range not exceeding a lower or higher limit value of the frequency; determining the charging/discharging amount of the storage battery based on the set charging/discharging amount; and transmitting a control command to the storage battery based on the determined charging/discharging amount.

In the electric power system control method according to the present invention, the determining of the charging/discharging amount of the storage batteries is determining the charging/discharging amount of a plurality of the storage batteries by using minimization of electric power conversion losses of the storage batteries as an objective function.

In addition, in the electric power system control method according to the present invention, the determining of the charging/discharging amount of the storage batteries is determining the charging/discharging amount of a plurality of the storage batteries by using reduction of deterioration of the storage batteries as an objective function.

### Advantageous Effects of Invention

According to the present invention, for a service provider who is supplied with an electric power necessary for electric power system control by designating an electric power amount from an ISO (independent system operator) and who controls the electric power necessary for the electric power system control including an ancillary service by using an electric power storage device including the storage batteries, it is possible to reduce the charging/discharging amount within a range where a frequency of the electric power system is not greatly changed. Herein, since the reduction of the charging/discharging amount leads to the reduction of the total electric power conversion loss at the time of charging/discharging, it is possible to reduce electric power lost as the electric power loss from the point of view of the storage battery service provider.

In addition, according to the present invention, it is possible to reduce electric power loss at the time of charging/discharging by a charging/discharging amount determination unit using efficiency curves of AC-DC converters connected to the storage batteries at the time of reducing a charging/discharging amount within a range where a frequency of an electric power system is not greatly changed. In addition, it is possible to implement a charging/discharging method of reducing deterioration of storage batteries by considering degrees of deterioration of the storage batteries.

### BRIEF DESCRIPTION OF DRAWINGS

FIG. 1 is a diagram illustrating a configuration of a first embodiment of the present invention;

FIG. 2 illustrates an example of change in frequency;

FIG. 3 illustrates an example of a relation between change in frequency and charging/discharging electric power;

FIG. 4 illustrates an example of displaying electric power in storage battery charging/discharging;

FIG. 5 is a diagram illustrating a configuration of a charging/discharging amount determination unit;

FIG. 6 illustrates an example of a flowchart of a discharging amount calculation unit according to a first embodiment;

FIG. 7 illustrates an example of a flowchart of an optimal dispatch calculation unit according to the first embodiment;

FIG. 8 is a diagram illustrating a configuration of a second embodiment of the present invention;

FIG. 9 illustrates an example of efficiency of an AC-DC converter;

FIG. 10 illustrates an example of a flowchart of an optimal dispatch calculation unit according to a second embodiment;

FIG. 11 is a diagram illustrating a configuration of a third embodiment of the present invention;

FIG. 12 illustrates an example of a chart diagram according to the third embodiment of the present invention;

FIG. 13 is a diagram illustrating a configuration of a fifth embodiment of the present invention; and

FIG. 14 illustrates an example of a chart diagram according to the fifth embodiment of the present invention.

### DESCRIPTION OF EMBODIMENTS

Hereinafter, embodiments of the present invention will be described with reference to the drawings. In addition, in the all figures for describing the embodiments, components having the same function are denoted by the same name and reference numeral, and redundant description thereof is omitted.

### First Embodiment

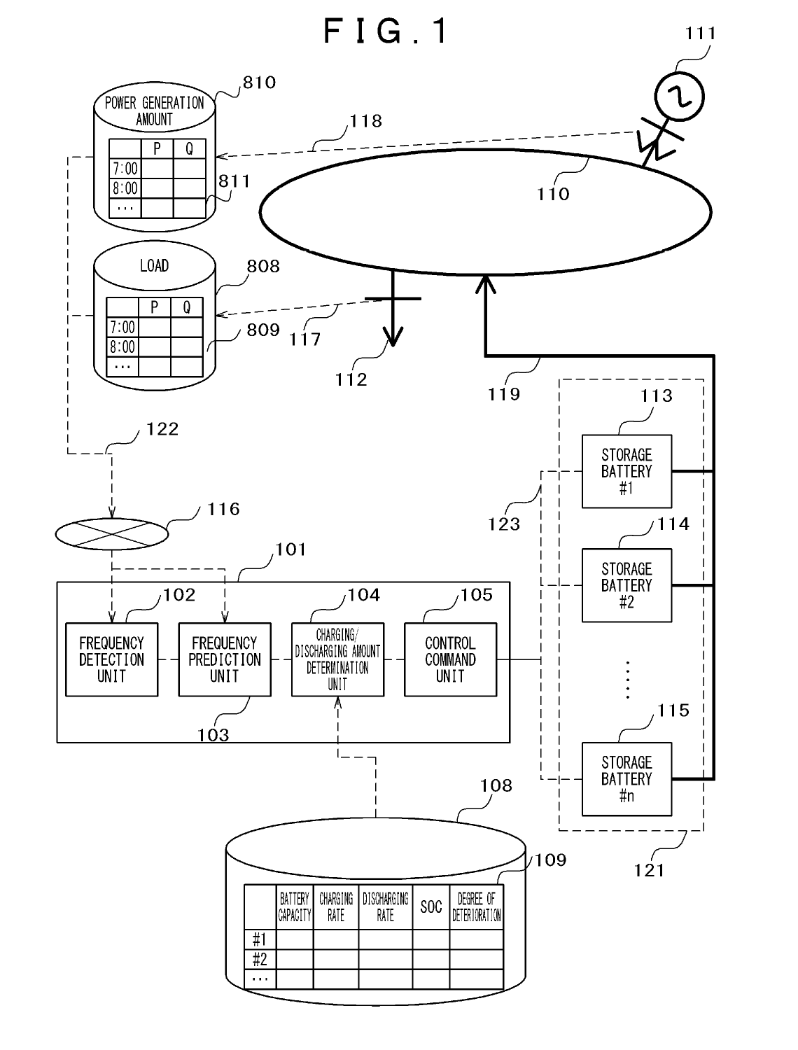

Hereinafter, a first embodiment of the present invention will be described with reference to the drawings. FIG. 1 illustrates a representative configuration of an electric power system control device according to the present invention. Reference numeral 101 denotes the electric power system control device according to the present invention. The electric power system control device is configured to include a frequency detection unit 102, a frequency prediction unit 103, a charging/discharging amount determination unit 104, and a control command unit 105. Input data of the frequency detection unit 102 and the frequency prediction unit 103 of the electric power system control device 101 are power generation amount data 810 through communication networks 118, 122, and 116 from a power generation facility 111 and load data 808 through communication networks 117, 122, and 116 from a load facility 112. In addition, as an example of the power generation amount data 810, there is a data table illustrated in 811. The table is configured with at least an active electric power output (in the figure, “P”) and a reactive electric power output (in the figure, “Q”) at each time. In addition, as an example of the load data 808, there is a data table illustrated in 809. The table is configured with at least an active electric power output (in the figure, “P”) and a reactive electric power output (in the figure, “Q”) at each time. In addition, as input data of the charging/discharging amount determination unit 104, there is a database of to-be-controlled storage batteries illustrated in a database 108. Data 109 of the storage batteries in the database include at least a battery capacity, a charging rate (indicating a speed of charging), a discharging rate (indicating a speed of discharging), a charging residual amount (SOC) of each to-be-controlled storage battery at the time point, and a degree of deterioration of each of the storage batteries. A storage battery group 121 is configured to include storage batteries 113, 114, and 115. The storage batteries transmit/receive a charging/discharging electric power amount based on control data transmitted through a signal line 123 from the electric power system control device 101 to/from the electric power system through a DC-AC converter which is not shown in the figure. The transmitted/received electric power is supplied to the electric power system 110 to contribute to stabilization of the electric power system.

The frequency detection unit 102 calculates the data from values of the power generation amount and load amount acquired through the network 116 by using the following formula.

[Mathematical Formula 1]

ΔP=KΔf (Equation 1)

Herein, ΔP denotes a change in load; K denotes a constant; and Δf denotes a change in frequency.

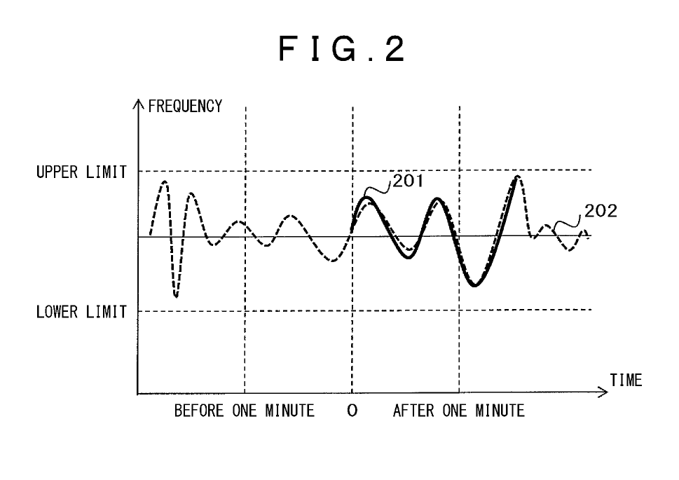

Next, the frequency prediction unit 103 will be described with reference FIG. 2. In FIG. 2, the horizontal axis denotes a time, and the vertical axis denotes a frequency of the electric power system. As illustrated in FIG. 2, as the frequency, there are an upper limit value and a lower limit value. In addition, in the figure, a solid line 201 indicates an actual result value of the frequency, and a broken line 202 indicates a predicted value of the frequency. If a power generation amount and a load amount of the electric power are set as a state variable x and the frequency is set as an observation value y, in the case of performing prediction, for example, by using a Kalman filter, the definition formula is expressed by Equation 2, and by calculating the value, the predicted frequency value of the solid line can be obtained as illustrated in FIG. 2.

[Mathematical Formula 2]

xₜ₊₁=Fxₜ+Gwₜ

yₜ=Hxₜ+vₜ (Equation 2)

Herein, F, G, and H denote coefficient matrices; w denotes a system noise; and v denotes an observation noise.

The input data of the frequency prediction unit 103 are the value of the frequency calculated by the frequency detection unit 102 and history data acquired through the network 116.

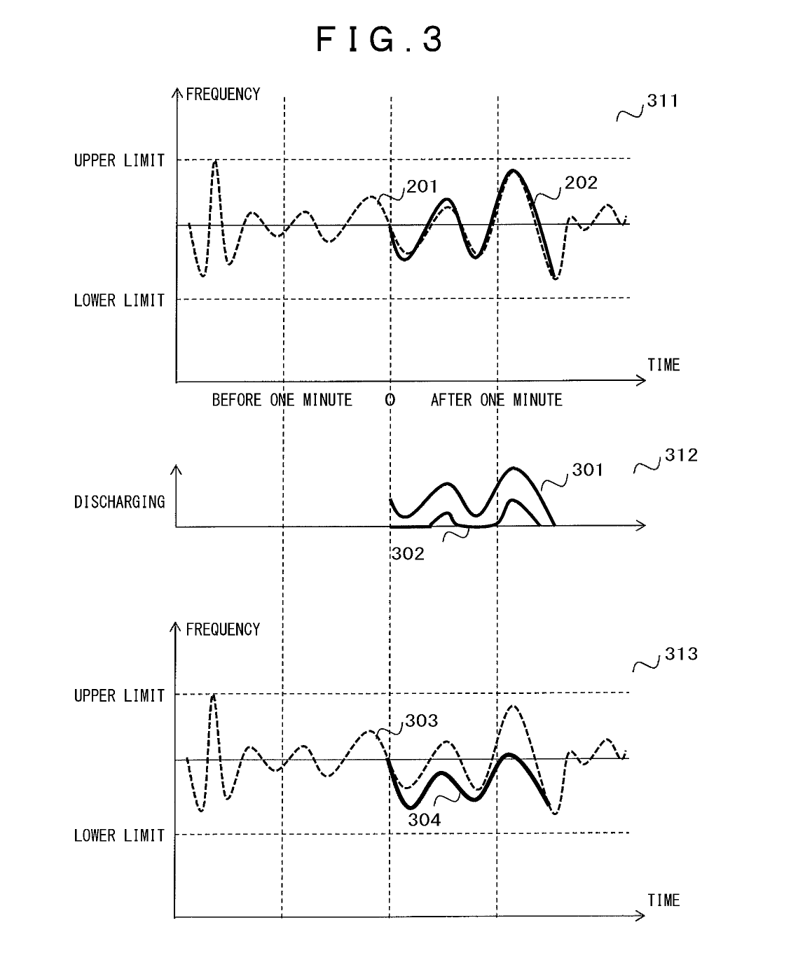

Next, the charging/discharging amount determination unit 104 will be described with reference to FIG. 3. A graph 311 of FIG. 3 is the same as the graph of FIG. 2. In a graph 312, the horizontal axis denotes a time, and the vertical axis denotes a discharging amount. In addition, a graph 313 illustrates the finished state of the frequency when the storage battery service provider changes the electric power charging/discharging amount by using the electric power system control device according to the present invention. A discharging amount 301 in the graph 312 is a charging/discharging amount commanded from the ISO or a charging/discharging amount contracted in the electric power market. In contrast, in the electric power system control device according to the present invention, as illustrated, by charging or discharging a discharging amount 302 in the graph 312, that is, an amount smaller than the electric power amount 301 with respect to electric power system according to the later-described method. As a result, the actual result value of the frequency becomes a value 304 in the graph 313, and in comparison with a predicted frequency value 303, the frequency is decreased in a range where the frequency is not near the lower limit of the frequency.

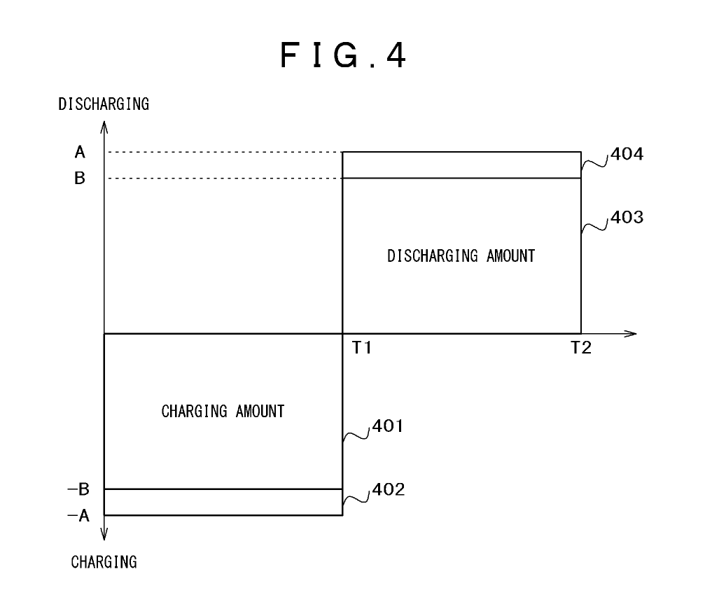

The reason for reducing the discharging amount in the embodiment will be described with reference to FIG. 4. In FIG. 4, the horizontal axis denotes a time, and the vertical axis denotes a charging/discharging amount. Typically, a bi-directional AC-DC converter is used for charging and discharging in the electric power system and the storage battery. The electric power losses occurring in the charging and discharging are 402 and 404. The storage battery service provider bears the electric power losses and performs charging/discharging (401 and 403) to participate in controlling the electric power system. Therefore, reduction of the electric power losses becomes a to-be-solved problem. Therefore, in order to reduce this value proportional to the charging/discharging amount, the total charging/discharging amount is to be reduced.

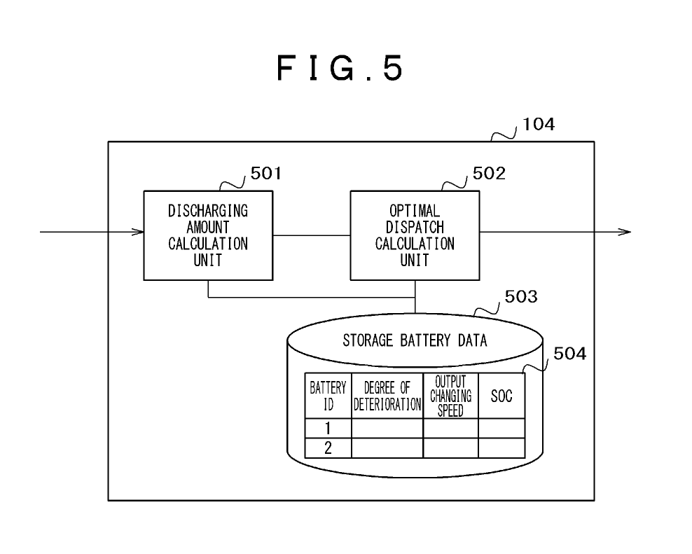

The charging/discharging amount determination unit 104 of reducing the total charging/discharging amount of the storage batteries in this manner will be described with reference to FIG. 5. The charging/discharging amount determination unit 104 is configured to include a discharging amount calculation unit 501, an optimal dispatch calculation unit 502, and a storage battery data 503 including at least a table 504 including storage battery IDs, degrees of deterioration, output changing speeds, and charging residual amounts (SOC) of storage batteries.

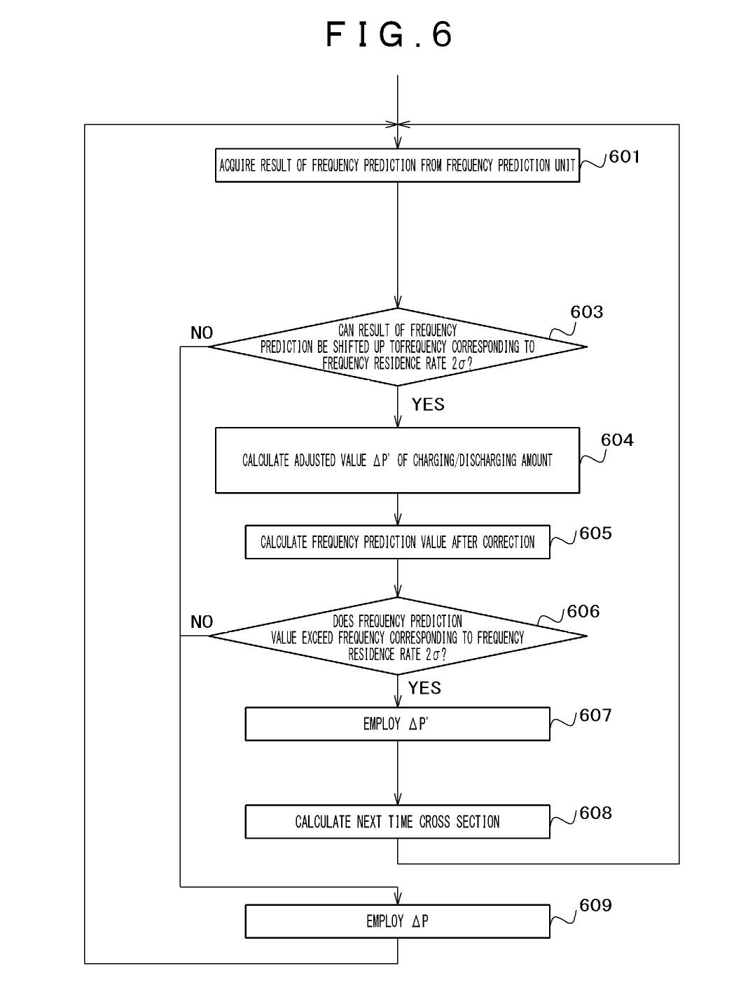

Next, detailed processes of the discharging amount calculation 501 will be described with reference to FIG. 6. In a process 601, time-series data of a result of frequency prediction (including command from the ISO and result of contract with the electric power market) are acquired from the frequency prediction unit 103. Next, in a process 603, it is determined whether or not the result of frequency prediction can be shifted up to the frequency where a frequency residence rate corresponds to 2σ (σ: standard deviation). In addition, the value of 2σ may be changed according to characteristics of the electric power system. If the determination is YES, in a process 604, an adjusted value ΔP′ of the charging/discharging amount is calculated. This can be obtained from the frequency corresponding to the residence rate of 2σ, a difference Δf′ of the predicted frequency, and a system constant by using the above-described Equation 1. Next, in the process 605, a predicted frequency value after correction is calculated. In a process 606, it is checked again whether or not the after-correction predicted frequency value calculated herein is included within the range of the frequency corresponding to the above-described frequency residence rate 2σ. In a case where the after-correction predicted frequency value is included within the range of the frequency corresponding to the frequency residence rate 2σ, in a process 607, ΔP′ is employed. In a process 608, calculation for the next time cross section is performed. In a case where the after-correction predicted frequency value is not included within the range of the frequency corresponding to the frequency residence rate 2σ in the process 606, the charging/discharging is performed according to the command from the ISO which is the original control value or the amount of the contract with the electric power market (process 609). In a case where the current frequency cannot be shifted to the frequency corresponding to the frequency residence rate 2σ in the process 603, in the process 609, the charging/discharging is performed according to the command from the ISO which is the original control value or the amount of the contract with the electric power market (process 609).

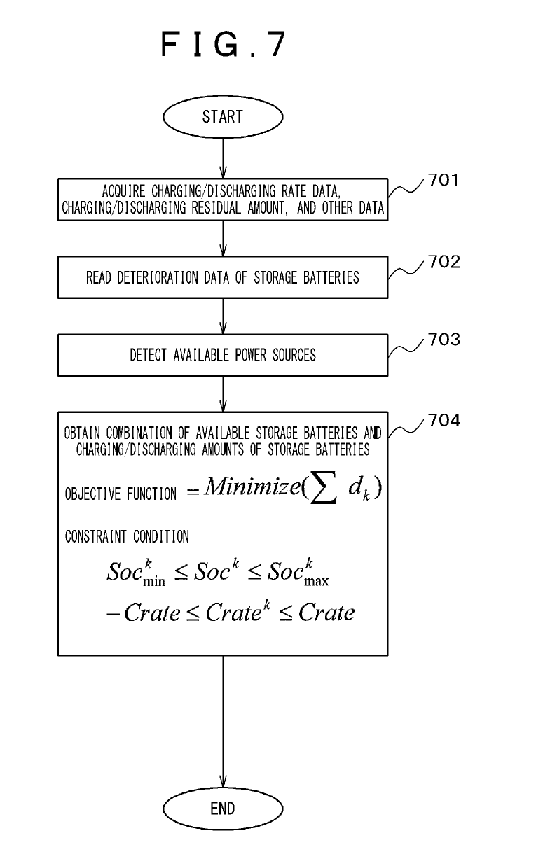

Next, the details of the optimal dispatch calculation unit 502 of FIG. 5 will be described with reference to FIG. 7. The optimal dispatch calculation unit 502 has a function of distributing the total electric power amount determined by the discharging amount calculation unit 501 to a plurality of the storage batteries. In a process 701, the function acquires the data required for the distribution calculation including the data of the charging/discharging rate and the charging/discharging residual amount (SOC). Next, in a process 702, deterioration data of the storage batteries are read. Herein, as the deterioration data of the storage batteries, the values output from the battery management units (BMUs) of the storage batteries omitted in FIG. 1 may be read, or simply, the values calculated based on the voltage values in the charging period may be read. Next, in a process 703, among a plurality of the storage batteries as control objects, the storage batteries available for charging/discharging control are detected. Next, in a process 704, a combination of the available storage batteries detected in the process 703 and the charging/discharging amounts of the storage batteries are obtained. Herein, with respect to the objective function, in terms that the lifecycles of the storage batteries are to be extended, a sum of indexes dk indicating the degrees of deterioration of the storage batteries is set to be minimized, and operation upper and lower limits of the SOC of the storage batteries and the charging/discharging change rates Crate of the storage batteries are set as constraint condition. In addition, the index dk indicating the degree of deterioration of the storage battery may be simply the deterioration data of the storage battery, a product of the deterioration data of the storage battery and an absolute value of the charging/discharging electric power amount, or a product of a releasing heat amount at the time of charging/discharging the storage battery and the charging/discharging electric power of the storage battery.

The calculation result of the charging/discharging amount determination unit 104 is transmitted to the control command unit 105. In the control command unit 105, considered are the control command values for the to-be-controlled storage batteries, for example, data of a combination of time, current, and voltage or data of a frequency increasing command and a frequency decreasing command (pulse) which is original data performing numerical conversion by the above-described BMUs of the storage battery side. The control command of the control command unit 105 is transmitted through the communication line 123 to each storage battery, and each BMU converts the transmitted data into a required data format and performs electric power control to contribute to stabilization control of the electric power system 110 through an electric power line 119.

In the first embodiment of the present invention, the electric power system control device for performing an ancillary service in which the storage battery service provider participates is configured with the frequency detection unit, the frequency prediction unit, the charging/discharging amount determination unit, and the control command unit, and since storage battery service provider can change the charging/discharging amount of the electric power system by sensing the system frequency within the range where disturbance does not occur in the system while the deterioration of the storage batteries is reduced, the burden of the electric power loss of the storage battery service provider can be decreased, and the degree of deterioration of the storage batteries can be reduced.

### Second Embodiment

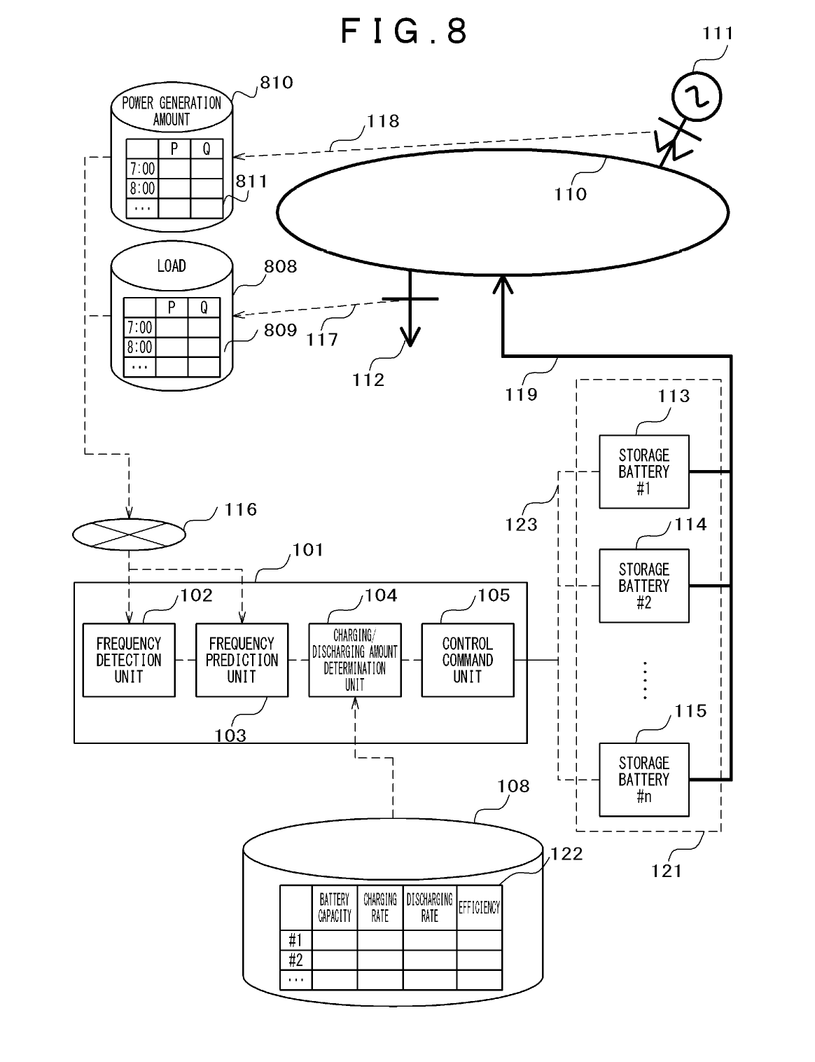

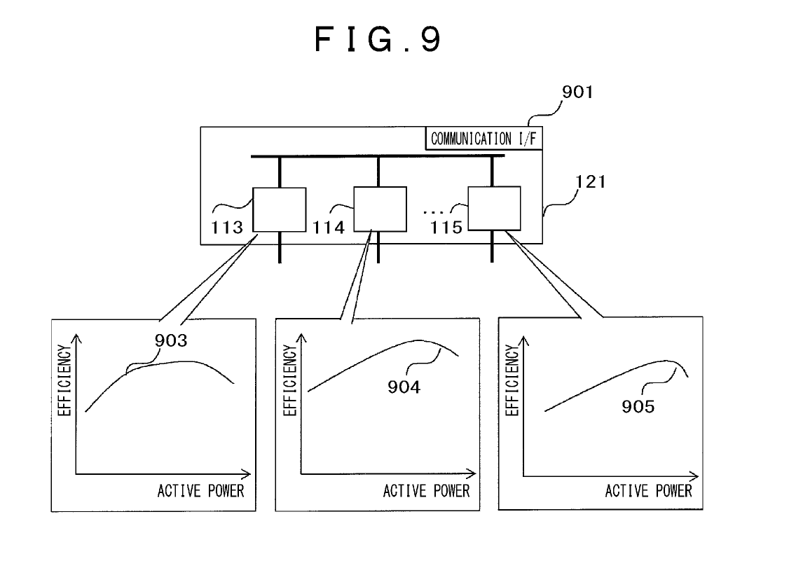

A second embodiment of the present invention is illustrated in FIG. 8. Unlike the first embodiment where the data about the deterioration of the storage batteries are used as the input data of the optimal dispatch calculation of the charging/discharging amount determination unit, in the second embodiment of the present invention, the optimal dispatch calculation on the storage batteries is performed by using the data about the efficiency of the AC-DC converters of the storage batteries 113, 114, and 115 (omitted in FIG. 8), so that the electric power loss of the storage batteries in the charging/discharging period is reduced. FIG. 8 is different from FIG. 1 in that the data table 122 in the database 108 is changed in comparison with that of FIG. 1. In the table 122, an efficiency curve of a DC-AC converter attached to each storage battery exists as a data item. An explanation diagram of the efficiency curve is illustrated in FIG. 9. The storage battery group 121 is connected to the communication network through a communication interface 901 which receives/transmits the control signal from/to the communication line 123. Efficiency curves of AC-DC converters of the storage batteries are denoted by 903 to 905. In the graphs of the efficiency curves 903 to 905, the horizontal axis denotes active electric power, and the vertical axis denotes efficiency. With respect to the efficiency curves, since the converters are different in characteristic, in many cases, the values of active electric power at the time when the efficiency has the highest peak are different, and in a case where the active electric power has the maximum output, the releasing heat causes the efficiency to be decreased, and the decreasing manners are different among the converters. In the embodiment, when the charging/discharging is performed on the storage batteries, the charging/discharging amounts of the storage batteries are determined so that the best efficiency is obtained over the entire to-be-controlled storage batteries.

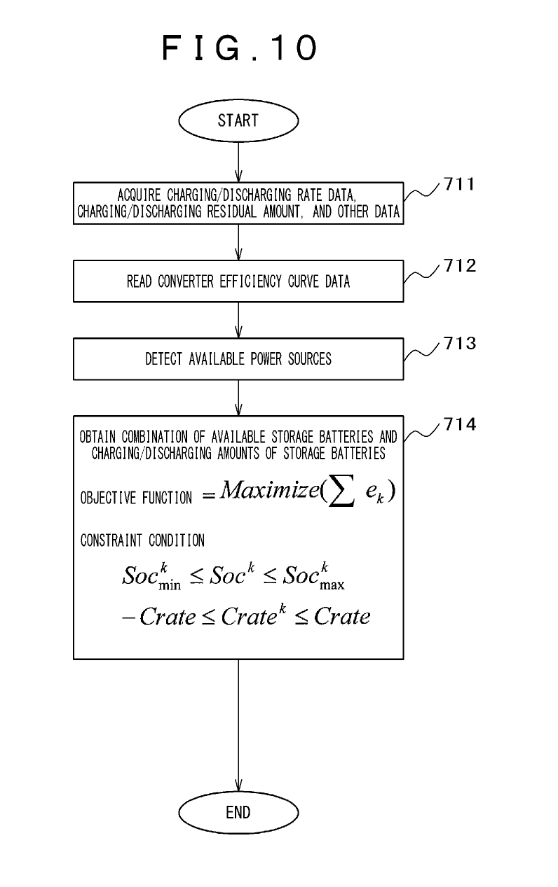

The details of the optimal dispatch calculation unit 502 according to the embodiment in FIG. 5 will be described with reference to FIG. 10. The optimal dispatch calculation unit 502 has a function of distributing the total electric power amount determined by the discharging amount calculation unit 501 to a plurality of the storage batteries. In a process 711, the function acquires the data required for the distribution calculation including the data of the charging/discharging rate and the charging/discharging residual amount (SOC). Next, in a process 712, converter efficiency curve data of the storage batteries are read. Herein, the data of deterioration of the storage batteries become the efficiency curve data determined in advance uniquely to the converters. Next, in a process 713, among a plurality of the to-be-controlled storage batteries, the storage batteries available for charging/discharging control are detected. Next, in a process 714, a combination of the available storage batteries obtained in the process 713 and the charging/discharging amounts of the storage batteries are obtained. Herein, with respect to the objective function, in terms that the entire storage batteries of interest are to have the best efficiency, a sum of indexes ek indicating the conversion efficiency of the converters of the storage batteries is set to be maximized, and operation upper and lower limits of the SOC of the storage batteries and the charging/discharging change rates Crate of the storage batteries are set as constraint condition. The other processes are the same as those of the first embodiment.

In the second embodiment of the present invention, the electric power system control device for performing an ancillary service in which the storage battery service provider participates is configured with the frequency detection unit, the frequency prediction unit, the charging/discharging amount determination unit, and the control command unit, and since the storage battery service provider can change the charging/discharging amount of the electric power system by sensing the system frequency within the range where disturbance does not occur in the system while conversion efficiency of the storage batteries is maximized, the burden of the electric power loss in the electric power supplying period and the charging/discharging period of the storage battery service provider can be decreased.

### Third Embodiment

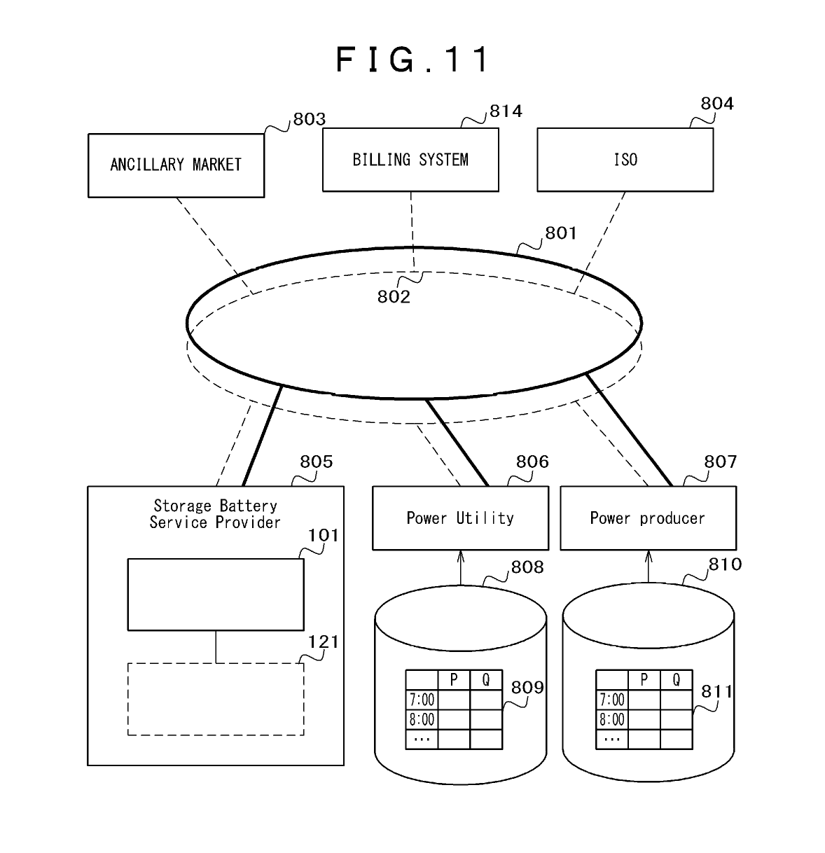

A third embodiment of the present invention is illustrated in FIG. 11. The third embodiment is an example of an electric power system using the electric power system control device according to the present invention described in the first embodiment. The electric power system is configured to include an electric power market 803, a billing system 814, an ISO 804, an electric power system 801, a communication network 802, a storage battery service provider 805, a power utility 806, and a power producer 807. The storage battery service provider 805 includes a storage battery group 121 and the electric power system control device according to the first embodiment. The electric power market 803 or the ISO 804 performs electric power reception/transmission command (time and amount) on the power producer 807 and the storage battery service provider 805 based on the result of the bid system (not shown in the figure). A command signal from these includes at least a storage battery number or a power generator number of a command destination, a power generation amount, a charging/discharging amount, a time of performing the power generation, and a time of performing charging/discharging. In addition, the data are allowed to be updated with a predetermined period. The command data from the ISO 804 to the storage battery service provider 805 and the power producer 807 are pulse signals received/transmitted through the network 802 in the same data format as that of the table illustrated in 809 and 811 in FIG. 11 or pulse signals commanding outputting and increasing or decreasing the current state value of the charging/discharging. In addition, other data formats may be used.

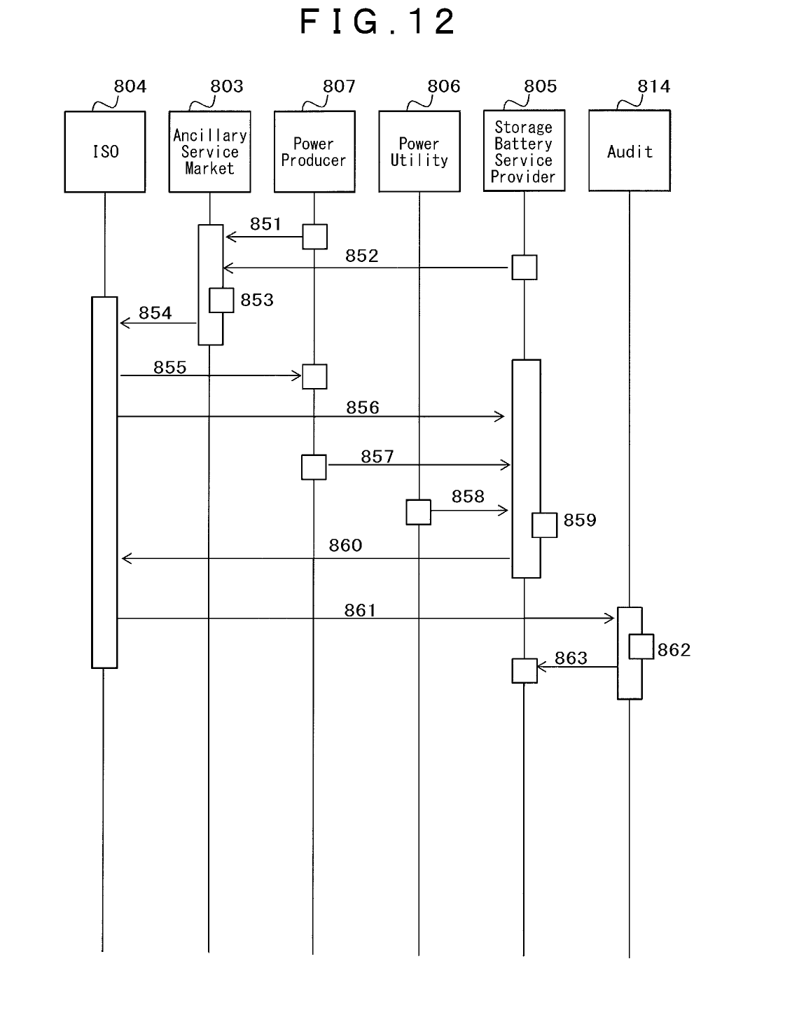

A chart diagram simplifying processes of the third embodiment of the present invention is illustrated in FIG. 12. First, in processes 851 and 852, the power producer 807 and the storage battery service provider 805 make bids in the electric power market 803. After the biding is ended, the electric power market determines the price, and in a process 853, the electric power market makes a contract. The electric power market notifies the result to the ISO 804 (process 854). For the control of the day, in processes 855 and 856, the IOS 804 issues a control command to the power producer and the storage battery service provider. In processes 857 and 858, the storage battery service provider acquires data about reception/transmission of the electric power. In a process 859, the storage battery service provider performs the processes described in the first embodiment. In a process 860, the storage battery service provider notifies the actual charging/discharging amount to the ISO. After the elapse of a predetermined time interval, in order to perform a billing payment process, in a process 861, the ISO 804 transmits payment data to the billing payment process 814. In a process 862, the billing payment process 814 checks excess or shortage and changes the electric power price dedicated to the storage battery service provider 805 according to the excess or shortage. In the process 862, by changing the price for the storage battery service provider 805, the incentive of performing the charging/discharging according to the command is provided, so that the ISO is allowed to perform the charging/discharging of the electric power according to the contract.

The third embodiment of the present invention is applied to the system configured to include the storage battery service provider including the electric power system control device, the ISO, the electric power market, the power producer, the power distributor, and the billing function, the electric power system control device is configured with the frequency detection unit, the frequency prediction unit, the charging/discharging amount determination unit, and the control command unit, and since the storage battery service provider can change the charging/discharging amount of the electric power system by sensing the system frequency within the range where disturbance does not occur in the system while the deterioration of the storage batteries is reduced, the burden of the electric power loss in the electric power supplying period and the charging/discharging period of the storage battery service provider can be decreased. In addition, the incentive is provided based on the difference between the contract result of the storage battery service provider and the charging/discharging amount, so that the electric power system having a stabilized supplying power over the entire system can be operated by the ISO.

### Fourth Embodiment

A fourth embodiment of the present invention has a configuration where the second embodiment is used to the electric power system control device according to the third embodiment illustrated in FIG. 11. This embodiment is different from the third embodiment in that the objective function of reducing the deterioration of the storage batteries in the third embodiment is replaced with the objective function of maximizing the efficiency of the converters. The details thereof are the same as those of the second embodiment.

The fourth embodiment of the present invention is applied to the system configured to include the storage battery service provider including the electric power system control device, the ISO, the electric power market, the power producer, the power distributor, and the billing function, the electric power system control device is configured with the frequency detection unit, the frequency prediction unit, the charging/discharging amount determination unit, and the control command unit, and since the storage battery service provider can change the charging/discharging amount of the electric power system by sensing the system frequency within the range where disturbance does not occur while the conversion efficiency of the storage batteries is maximized, the burden of the electric power loss in the electric power supplying period and the charging/discharging period of the storage battery service provider can be decreased. In addition, the incentive is provided based on the difference between the contract result of the storage battery service provider and the charging/discharging amount, so that the electric power system having a stabilized supplying power over the entire system can be operated by the ISO.

### Fifth Embodiment

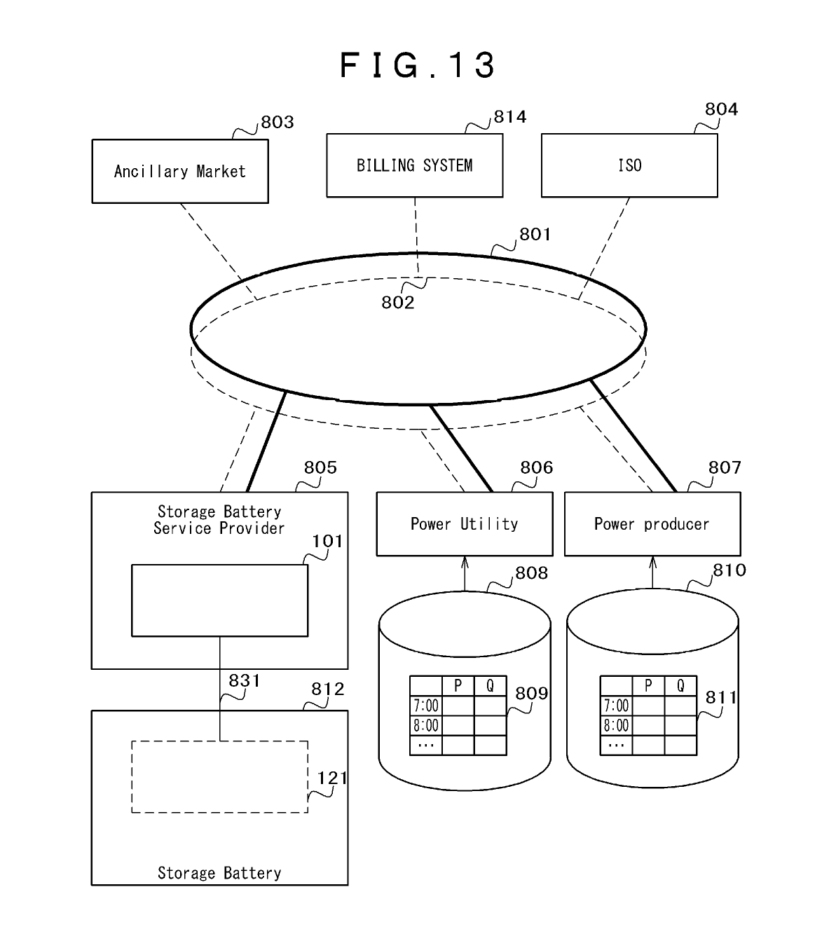

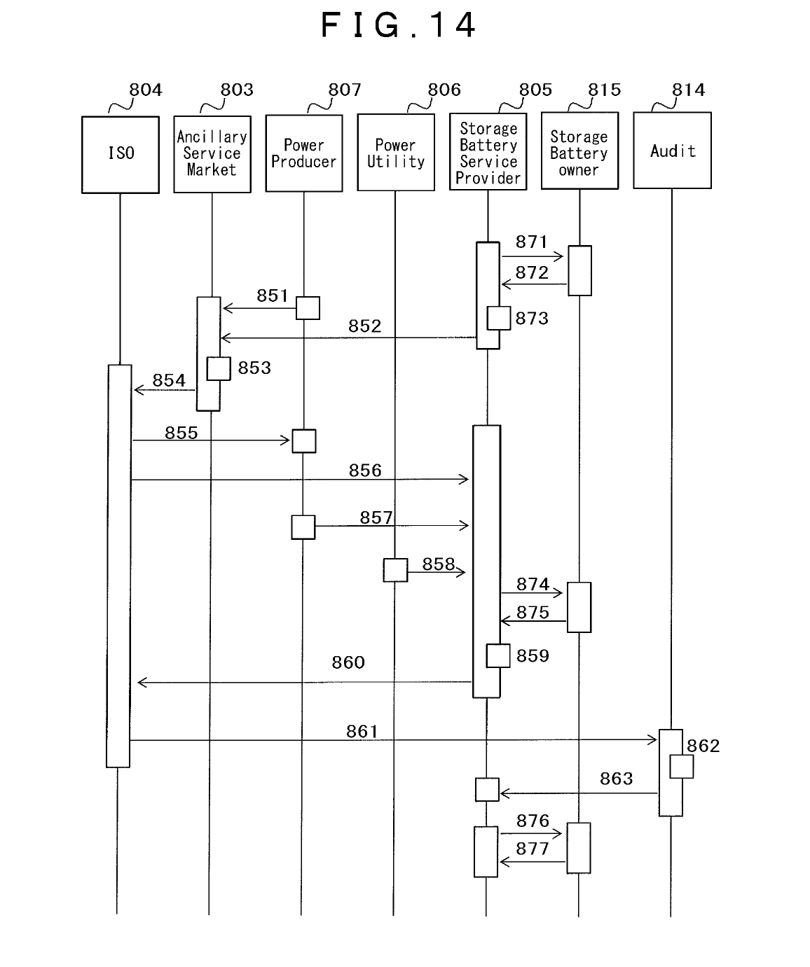

A fifth embodiment of the present invention is illustrated in FIG. 13. In comparison with the third embodiment, the fifth embodiment of the present invention is a case where storage batteries of a storage battery service provider become a storage battery owner of a third party. In this case, there is a difference in that data exchange between the storage battery service provider 805 and the storage battery owner 812 is performed through the network 831, and the storage battery service provider 805 appropriately queries the storage battery owner 812 about the data at the time of using the data. Main differences from the third embodiment will be described with reference to a chart diagram of FIG. 14. In comparison with the chart diagram of FIG. 12, in the chart diagram of FIG. 14, the storage battery owner 815 is increased, and thus, the processes from 871 to 877 are increased. In the case of the bidding for the electric power market, unlike the third embodiment where the storage battery group 121 and the electric power system control device 101 are entered into the same function, in this embodiment, since the two functions are separated, in the biding period (request signal 871, reply signal 872), the communication result is obtained from the storage battery owner, in the classification process (873) of the available storage batteries, signals in the control execution period (request signal 874, control-execution-completed signal 875) and signal in the billing period (notification signal 876, verification-completed signal 877) are increased. The others are the same as those of the third embodiment.

The fifth embodiment of the present invention is applied to the system configured include the storage battery service provider including the electric power system control device, the storage battery owner, the ISO, the electric power market, the power producer, the power distributor, and the billing function, the electric power system control device is configured with the frequency detection unit, the frequency prediction unit, the charging/discharging amount determination unit, and the control command unit, and since the storage battery service provider can change the charging/discharging amount of the electric power system by sensing the system frequency within the range where disturbance does not occur while the deterioration of the storage batteries is reduced, the burden of the electric power loss in the electric power supplying period and the charging/discharging period of the storage battery service provider can be decreased. In addition, the incentive is provided based on the difference between the contract result of the storage battery service provider and the charging/discharging amount, so that the electric power system having a stabilized supplying power over the entire system can be operated by the ISO.

### Sixth Embodiment

In comparison with the fourth embodiment, a sixth embodiment of the present invention is a case where storage batteries of a storage battery service provider become a storage battery owner of a third party. In this case, there is a difference in that data exchange between the storage battery service provider 805 and the storage battery owner 812 is performed through the network 831, and the storage battery service provider 805 appropriately queries the storage battery owner 812 about the data at the time of using the data. Main differences from the fourth embodiment will be described with reference to the chart diagram of FIG. 14. In comparison with the chart diagram of FIG. 12, in the chart diagram of FIG. 14, the storage battery owner 815 is increased, and thus, the processes from 871 to 877 are increased. In the case of the bidding for the electric power market, unlike the third embodiment where the storage battery group 121 and the electric power system control device 101 are entered into the same function, in this embodiment, since the two functions are separated, in the biding period (request signal 871, reply signal 872), the communication result is obtained from the storage battery owner, in the classification process (873) of the available storage batteries, signals in the control execution period (request signal 874, control-execution-completed signal 875) and signal in the billing period (notification signal 876, verification-completed signal 877) are increased. The others are the same as those of the third embodiment.

The sixth embodiment of the present invention is applied to the system configured to include the storage battery service provider including the electric power system control device, the storage battery owner, the ISO, the electric power market, the power producer, the power distributor, and the billing function, the electric power system control device is configured with the frequency detection unit, the frequency prediction unit, the charging/discharging amount determination unit, and the control command unit, and since the storage battery service provider can change the charging/discharging amount of the electric power system by sensing the system frequency within the range where disturbance does not occur while the conversion efficiency of the storage batteries is maximized, the burden of the electric power loss in the electric power supplying period and the charging/discharging period of the storage battery service provider can be decreased. In addition, the incentive is provided based on the difference between the contract result of the storage battery service provider and the charging/discharging amount, so that the electric power system having a stabilized supplying power over the entire system can be operated by the ISO.

### REFERENCE SIGNS LIST

101: Electric power system control device
102: Frequency detection unit
103: Frequency prediction unit
104: Charging/discharging amount determination unit
105: Control command unit
108: Database
110: Electric power system
111: Power generation facility
112: Load facility
113 to 115: Storage batteries
119: Electric power line
201: Frequency actual result value
202: Predicted frequency value
501: Discharging amount calculation unit
502: Optimal dispatch calculation unit
503: Storage battery database
801: Electric power system
802: Communication line
803: Electric power market
804: ISO
805: Storage battery service provider
806: Power utility
807: Power producer
808: Load database
810: Power generation amount database
812: Storage battery owner
814: Billing system
903 to 905: Converter efficiency curves

1. An electric power system control device of maintaining a balance of power supply and demand of an electric power system by controlling charging/discharging of a storage battery associated with the electric power system based on a predicted frequency value after several seconds or minutes of the electric power system, comprising:
a frequency detection unit which calculates a frequency of the electric power system;
a frequency prediction unit which predicts the frequency from the value of the frequency calculated by the frequency detection unit and history data of power generation/load supply-demand data;
a charging/discharging amount determination unit which sets a charging/discharging amount corresponding to a value lower or higher than the predicted frequency value of the electric power system predicted by the frequency prediction unit within a range not exceeding a lower or higher limit value of the frequency and determines the charging/discharging amount of the storage battery based on the value; and
a control command unit which transmits a control command to the storage battery based on a result of the charging/discharging amount determination unit.

2. The electric power system control device according to claim 1, wherein the charging/discharging amount determination unit is configured to include a discharging amount calculation unit and an optimal dispatch calculation unit.

3. The electric power system control device according to claim 2, wherein the discharging amount calculation unit determines whether or not the predicted frequency value can be shifted to a predetermined frequency, calculates an adjusted value of the charging/discharging amount, calculates an after-correction predicted frequency value, and employs the adjusted value of the charging/discharging amount in a case where the after-correction predicted frequency value is included within a predetermined frequency range.

4. The electric power system control device according to claim 3, wherein the predetermined frequency is a frequency of which a frequency residence rate corresponds to 2σ (σ: standard deviation).

5. The electric power system control device according to claim 2, wherein the optimal dispatch calculation unit determines the charging/discharging amount of a plurality of the storage batteries by using reduction of deterioration of the storage batteries as an objective function.

6. The electric power system control device according to claim 5, comprising storage battery data including at least degrees of deterioration of the storage batteries.

7. The electric power system control device according to claim 2, wherein the optimal dispatch calculation unit determines the charging/discharging amount of a plurality of the storage batteries by using minimization of electric power conversion losses of the storage batteries as an objective function.

8. The electric power system control device according to claim 7, comprising data about at least efficiency of AC-DC converters of the storage batteries.

9. An electric power system comprising:
a storage battery service provider having the electric power system control device according to claim 1 and a storage battery group;
an electric power market;
a billing system;
an independent system operator;
a power producer; and
an electric power service provider.

10. An electric power system comprising:
a storage battery service provider having the electric power system control device according to claim 1;
a storage battery owner having a storage battery group;
an electric power market;
a billing system;
an independent system operator;
a power producer; and
an electric power service provider.

11. An electric power system control method of maintaining a balance of power supply and demand of an electric power system by controlling charging/discharging of a storage battery associated with the electric power system based on a predicted frequency value after several seconds or minutes of the electric power system, comprising:
calculating a frequency of the electric power system;
predicting the frequency from history data including a value of the calculated frequency and power generation/load supply-demand data;
setting a charging/discharging amount of the storage battery corresponding to a value lower or higher than the predicted frequency value of the electric power system within a range not exceeding a lower or higher limit value of the frequency;
determining the charging/discharging amount of the storage battery based on the set charging/discharging amount; and
transmitting a control command to the storage battery based on the determined charging/discharging amount.

12. The electric power system control method according to claim 11, wherein the setting of the charging/discharging amount is determining whether or not the predicted frequency value can be shifted to a predetermined frequency, calculating an adjusted value of the charging/discharging amount, calculating an after-correction predicted frequency value, and employing the adjusted value of the charging/discharging amount in a case where the after-correction predicted frequency value is included within a predetermined frequency range.

13. The electric power system control method according to claim 11, wherein the determining of the charging/discharging amount of the storage battery is determining the charging/discharging amount of a plurality of the storage batteries by using reduction of deterioration of the storage batteries as an objective function.

14. The electric power system control method according to claim 11, wherein the determining of the charging/discharging amount of the storage battery is determining the charging/discharging amount of a plurality of the storage batteries by using minimization of electric power conversion losses of the storage batteries as an objective function.
